(19) United States
(12) Patent Application Publication
(10) Pub. No.: US 2010/0225066 A1
(43) Pub. Date: Sep. 9, 2010

(54) Separable glands for cartridge seal

(76) Inventor: Yi-Chieh Huang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,890

(22) Filed: Mar. 4, 2009

(51) Int. Cl. F16J 15/00

(52) U.S. Cl. 277/579

(57) ABSTRACT

Separable glands for a cartridge seal includes an outer gland, and an inner gland assembly, which is separable from the outer gland, and consists of all necessary parts of a cartridge seal, including an inner gland; in installation, the outer gland is fixed on an rotating equipment to restrain the inner gland assembly; the outer gland can be rotated to make its peripheral gaps to face threaded holes of the rotating equipment before it is fixed; the outer gland is stopped from falling off with a loosen-prevention component, e.g. elastic piece and fastener; the inner gland has an outer adjoining portion, and the outer gland has an inner adjoining portion, which will come closely in contact with the outer adjoining portion to prevent the inner gland assembly from loosening; after a cartridge seal is removed for replacement of the inner gland assembly, the outer gland will be used again together with a new inner gland assembly.

### BACKGROUND OF THE INVENTION

1. Field of the Invention

The present invention relates to separable glands for a cartridge seal, most particularly in the composition of an inner gland assembly and an outer gland. The inner and the outer glands are two separated parts, which makes a cartridge seal easy to install, repair and maintain. Moreover, it reduces the cartridge seal cost because the inner and the outer glands are made of different materials. In installation, the outer gland can be rotated to make its slots face the threaded holes of a rotating equipment and it is fixed in position with the bolts respectively.

2. Brief Description of the Prior Art

Referring to FIG. 11, Taiwan Patent No. 592261 “a Stationary Ring and a Spring-Biased Guiding Piece of a Shaft Seal” is a shaft seal structure, which includes the following:

1. Sleeve 5; it has a tail covering portion 51, which has a greater diameter than other portions of the sleeve 5; a rotary friction ring 52 is positioned around the sleeve 5, adjoining the tail covering portion 51;

2. Body (gland) 6; it has a through holding room 61, which extends from one end to the other end of the body 6; the body 6 has several fluid passages 62 thereon;

3. Stationary friction ring 7, which is positioned around the sleeve 5, and comes into contact with the rotary friction ring 52 at one lateral side thereof;

4. Stationary ring 8, which is secured in the body 6; it has several recess holes 81 on a first lateral side thereof; each recess holes 81 holds a compressive element 82, which stick out from the surface of the stationary ring 8; and

5. Guiding piece 9, which is positioned around the sleeve 5, and between the stationary friction ring 7 and the stationary ring 8; the guiding piece 9 is pushed by compressive element 82 to press the stationary friction ring 7 against the rotary friction ring 52; the stationary ring 8 has several guiding recess portions 83 while the guiding piece 9 has several protrusions 91 in both sides, which are fitted in the guiding recess portions 83 and the stationary friction ring 7 respectively, it ensures the guiding piece 9 to move only in an axial direction relative to the stationary ring 8.

Conventional shaft seal is found to have the following drawbacks when it is put into practical use:

1. The body (gland) of such a shaft seal is a single monolithic part, and such single body is custom made and has a fixed location over the rotating equipment. Thereby, a series of similar glands with different mounting positions have to be monitored; it requires relatively more effort and time consuming to install every shaft seal correctly.

2. Since the body is a single part, the whole gland has to be replaced every time the inner portion of the body is worn out. In contrast to the two pieces gland (inner body and outer body), the wearable inner body is the only one being renewed. Consequently, it has enormous amount of material and economic benefits.

3. In installation for larger diameter gland, it is difficult for the technician to mount the shaft seal, particularly when the shaft seal needs to be rotated. The technician has to turn the whole shaft seal. Conversely, in two pieces gland, the technician has to rotate the outer body alone.

4. Tightening the nuts to fasten the gland of the shaft seal is normally in a diagonal or crossway manner, to ensure flatness and tightness evenly around the gland. Similarly with the two pieces gland, uniform distribution of force around the bodies is assured; because the adjoining portions between the inner and outer glands are coupled and capable of self-alignment, even if bolting is not in sequence. Thus, the contact between the shaft seal and the rotating equipment is sound and reliable.

### SUMMARY OF THE INVENTION

It is the main object of the present invention to provide an improvement on separable glands for a cartridge seal, to overcome the above problems; the separable glands for a cartridge seal include an inner gland assembly and an outer gland, which are separable; the inner gland assembly consists of all necessary parts of a common cartridge seal, including an inner gland. The inner and the outer glands can be made of different materials to reduce the material cost or made of the same materials. And, the outer gland can be used forever; after a cartridge seal is removed for replacement of the inner gland assembly, the outer gland can be used together with a new inner gland assembly. Therefore, the cartridge seal is relatively economical to use.

In accordance with an embodiment of the invention, the separable glands for a cartridge seal includes an inner gland assembly, and an outer gland; the inner gland assembly consists of all necessary parts of a common cartridge seal, which are packaged and sealed together, including a sleeve, and at least one inner gland; the sleeve is positioned around a shaft of an rotating equipment; the inner gland serves as a supporting base for other parts, and has passages therein for process fluid to circulate therethrough. The outer gland is fixed on the rotating equipment to restrain the inner gland assembly; thus, it seals the shaft perfectly. The material of the inner gland has to be chosen from a group of materials with different anticorrosive capabilities according to the property of the process fluid. The outer gland doesn't have passages therein for the process fluid to pass through therefore it isn't necessary for the outer gland to be made of special materials; the outer gland is only made of relatively inexpensive ordinary materials, thus helping to save the resources and reduce the material cost of the cartridge seal. The inner and the outer glands have adjoining portions, which will come closely in contact with each other after installation. The inner gland has an annular groove, and at least one loosen-prevention component is positioned around the annular groove of the inner gland to prevent the outer gland from falling off while the outer gland still can be rotated to a proper position in installation; the loosen-prevention component can be an elastic piece or a fastener.

The adjoining portions of the inner and the outer glands can have step-shaped, vertical, sloping and bending sections; the adjoining portions will come closely in contact with each other no matter what shape they are formed with; the combination of the inner gland, the sleeve, the sealing rings and other related parts is restrained with the outer gland, and it can be replaced with a new one, making the seal convenient and economical to use.

### BRIEF DESCRIPTION OF THE DRAWINGS

The present invention will be better understood by referring to the accompanying drawings, wherein:

FIG. 1 is an exploded perspective view of a first preferred embodiment in the present invention,

FIG. 2 is a side view of the first preferred embodiment,

FIG. 3 is an enlarged partial side view of the first embodiment,

FIG. 4 is an enlarged partial side view of a second preferred embodiment in the present invention,

FIG. 5 is an enlarged partial side view of a third preferred embodiment in the present invention,

FIG. 6 is an enlarged partial side view of a fourth preferred embodiment in the present invention,

FIG. 7 is an enlarged partial side view of a fifth preferred embodiment in the present invention,

FIG. 8 is an enlarged partial side view of a sixth preferred embodiment in the present invention,

FIG. 9 is an enlarged partial side view of a seventh preferred embodiment in the present invention,

FIG. 10 is an exploded perspective view of an eighth preferred embodiment in the present invention, and

FIG. 11 is an exploded perspective view of the prior art.

### DETAILED DESCRIPTION OF THE PREFERRED EMBODIMENTS

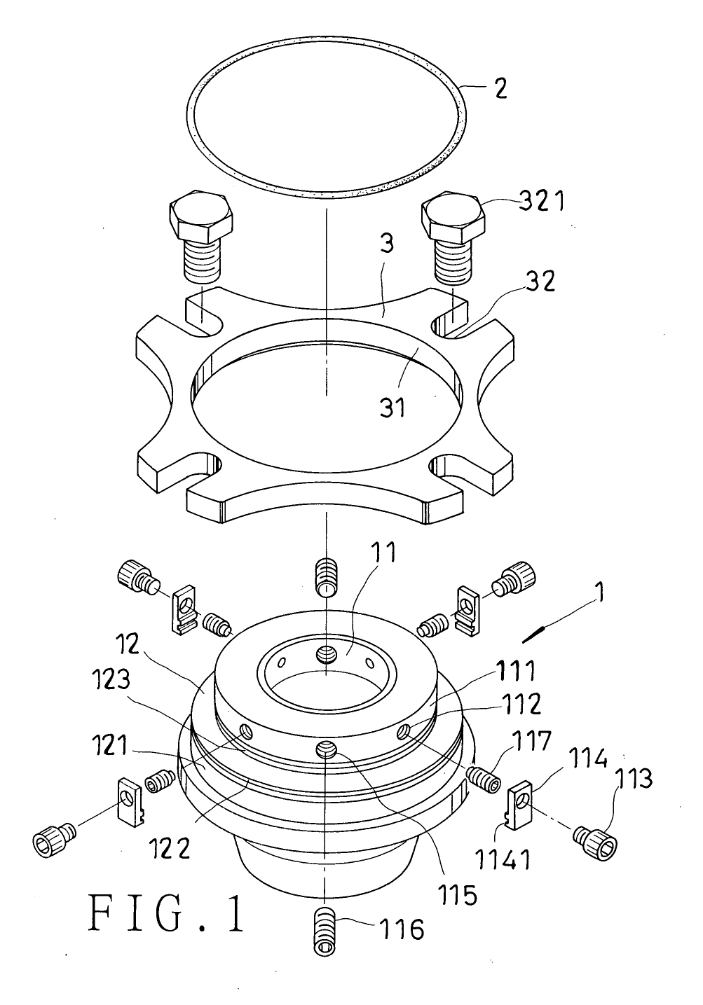

Referring to FIG. 1, a first preferred embodiment of the present invention consists of an inner gland assembly 1, at least one loosen-prevention component 2, and an outer gland 3.

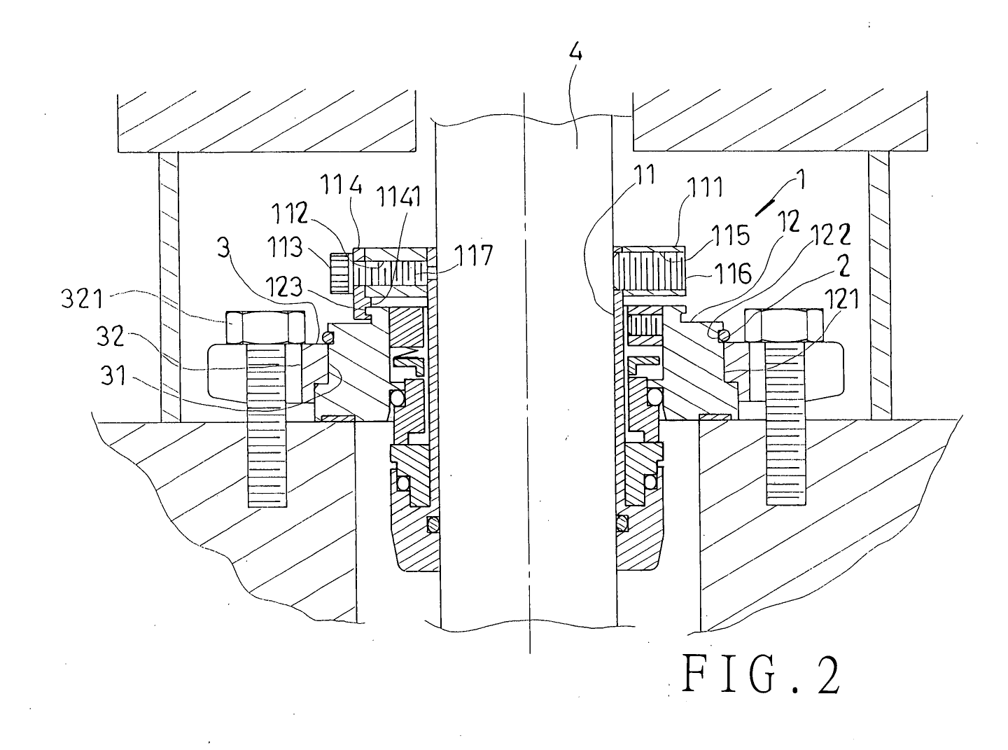

The inner gland assembly 1 consists of all necessary parts of a common cartridge seal, which are packaged and sealed together; the inner gland assembly 1 includes a sleeve 11 and at least one inner gland 12, and it is positioned around a shaft 4, as shown in FIG. 2. An collar 111 is positioned around an upper portion of the sleeve 11; the collar 111 has several large threaded holes 115 on a circumferential side, which extends in a radial direction of the O-ring 111; each of the large threaded holes 115 has a large threaded fixing element 116 joined thereto. The large threaded fixing elements 116 are passed through the sleeve 11 and tightly pressed against the shaft 4. The collar 111 has several small threaded holes 112 on a circumferential side, which extends in a radial direction of the collar 111; each of the small threaded holes 112 has a small transmission elements 117 securely joined therein; the small transmission elements 117 are passed into holes on a circumference of the sleeve 11, yet they don't stick out from an inner side of the sleeve 11.

The inner gland 12 is slightly depressed such that a small space exists between the inner gland 12 and the collar 111. The inner gland 12 has an annular protrusion 123. The inner gland assembly 1 further includes several fixing pieces 114, which are fixed next to the small threaded holes 112 respectively; small threaded fixing elements 113 are passed through the fixing pieces 114, and joined in the small threaded holes 112 so as to fix the fixing pieces 114 on the collar 111. The fixing pieces 114 are in the shape of an inverted “F”, each having a sandwiching portion 1141; in installation, the fixing pieces 114 and the small threaded fixing elements 113 will be temporarily joined on the collar 111 and the inner gland 12 with the sandwiching portions 1141 of the fixing pieces 114 being joined on the annular protrusion 123 of the inner gland 12 for allowing the collar 111 to fixed in a correct position with its center being on an axis of the shaft 4. Process fluid will circulate in the inner gland 12; the material of the inner gland 12 has to be chosen from a group of materials with different anticorrosive capabilities according to the property of the process fluid. The inner gland 12 has on an outer side thereof an adjoining portion 121 to adjoin the outer gland 3; the outer adjoining portion 121 is step-shaped, and includes an upper section, and a lower section having a greater diameter than the upper section; the outer adjoining portion 121 can have sloping sides 1241 thereon. The inner gland 12 further has an annular groove 122 thereon, which is next to an upper end of the outer adjoining portion 121.

The loosen-prevention component 2 can be an elastic piece or a fastener, and it is positioned around the annular groove 122 of the inner gland 12 to help to prevent the outer gland 3 from separating from the inner gland 12.

The outer gland 3 has an adjoining portion 31 on an inner side thereof, which includes an upper section, and a lower section having a greater diameter than the upper section. The outer gland 3 is pressed on the inner gland 12 with its adjoining portion 31 being closely in contact with the adjoining portion 121 of the inner gland 12. The outer gland 3 can match up with different models of inner gland assemblies 1 and cartridge seals with different model numbers; in other words, cartridge seals with different diameters and made in accordance with different standards, e.g. ISO/DIN/ANSI/API, can match up well in the present invention. The outer gland 3 isn't formed with passages of the process fluid therefore it isn't necessary for the outer gland 3 to be made of special materials; in other words, the outer gland 3 is made of ordinary materials, which is relatively inexpensive. Furthermore, the outer gland 3 has several slots 32 on an outward edge thereof. The outer gland 3 is securely joined on an outer side of a hollow body of a rotating equipment by means of bolts 321, which are passed through the slots 32 respectively, and secured to the hollow body of the rotating equipment.

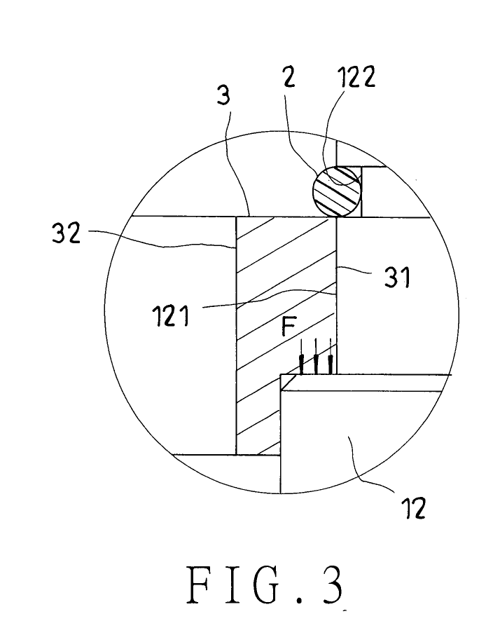

Referring to FIGS. 1 and 2, the separable glands for a cartridge seal of the present invention is installed on a rotating equipment according to a first method, which includes the following steps: first, the outer gland 3 is positioned around the inner gland assembly 1 so that the adjoining portion 31 of the outer gland 3 is closely in contact with the outer adjoining portion 121 of the inner gland 12; second, referring to FIG. 3 as well, the loosen-prevention component 2 is positioned on the annular groove 122 of the inner gland 12 so that the outer gland 3 can't separate from the inner gland 12, yet it still can be rotated; third, the combination of the inner gland assembly 1 and the outer gland 3 is passed through the shaft 4, and the outer gland 3 is turned so that the slots 32 face threaded holes of the rotating equipment respectively; fourth, the bolts 321 are passed through the slots 32 to fix the outer gland 3 on the fixing side of the shaft box of the rotating equipment, and the large threaded fixing elements 116 are securely joined on the shaft 4; finally, the small threaded fixing elements 113 and the fixing pieces 114 are removed. Therefore, the inner gland 12 is fixed in position by means of the outer gland 3 and the bolts 321 with the adjoining portion 121 of the inner gland 12 and the adjoining portion 31 of the outer gland 3 being closely in contact with each other. The bolts 321 aren't directly joined on the inner gland assembly 1. In other words, the inner gland assembly 1 is indirectly fastened with the bolts 321, which make the outer gland 3 pressed against the inner gland 12; the adjoining portion 121 of the inner gland 12 will be always subjected to a uniformly distributed force from the outer gland 3 no matter in what order the bolts 321 are turned to the fastening position. Therefore, it takes less labor and time to install the cartridge seal after the cartridge seal has been separated from the rotating equipment for allowing the cartridge seal to be repaired and maintained. After the bolts 321 are turned to the fastening position, the adjoining portion 31 will come completely in contact with the adjoining portion 121, and in turn the inner and the outer glands 12 and 3 will be subjected to a more uniformly distributed pressure. Consequently, the inner and the outer glands 12 and 3 can't deform or loosen even if they are subjected to high pressure or vibration for a long period of time.

The separable glands for a cartridge seal of the present invention can be installed according to a second method, which includes the following steps: first, the inner gland assembly 1 is passed through the shaft 4, and the outer gland 3 is positioned around the inner gland assembly 1 so that the adjoining portion 31 comes into contact with the adjoining portion 121 on the outer side of the inner gland 12; second, at least one loosen-prevention component 2 is joined on the annular groove 122 of the inner gland 12; third, the outer gland 3 is turned until the slots 32 face the threaded holes of the rotating equipment respectively; fourth, the bolts 321 are used to fix the outer gland 3 on the fixing side of the shaft box of the rotating equipment, and the large threaded fixing elements 116 are passed through the large threaded holes 115 of the collar 111, and turned to the fastening position, wherein the large threaded fixing elements 116 are closely in contact with the shaft 4; finally, the small threaded fixing elements 113 and the fixing pieces 114 can be removed and used to adjust the cartridge seal to install in a correct position.

Referring to FIGS. 1 and 2, if the inner gland assembly 1 is damaged, the cartridge seal of the present invention can be removed from the rotating equipment according to the following steps for allowing the inner gland assembly 1 to be repaired, maintained or replaced with a new one: first, the large threaded fixing elements 116 are loosened, and the bolts 321 removed; second, the combination of the inner gland assembly 1 and the outer gland 3 is separated from the shaft 4, and at least one loosen-prevention component 2 is separated from the annular groove 122 of the inner gland 12; finally, the inner gland assembly 1 is separated from the outer gland 3 to be repaired and maintained. Next, a new inner gland assembly is joined to the original outer gland 3, which can be used forever. The original outer gland 3 and the new inner gland assembly can be joined together and installed according to the following steps: first, the outer gland 3 is positioned so as to come closely in contact with the inner gland assembly 1; second, at least one loosen-prevention component 2 is positioned on the annular groove 122 of the inner gland 12; third, the combination of the inner gland assembly and the outer gland 3 is positioned around the shaft 4, and the outer gland 3 is turned so that the slots 32 face the threaded holes of the rotating equipment respectively; fourth, the bolts 321 are passed through the slots 32 to fix the outer gland 3 on the fixing side of the shaft box of the rotating equipment, and the large threaded fixing elements 116 are securely joined on the shaft 4; finally, the small threaded fixing elements 113 and the fixing pieces 114 are removed. The cartridge seal of the present invention is economical to use because the outer gland 3 can be used forever, not having to be replaced.

Or alternatively, the original outer gland 3 and the new inner gland assembly can be joined together and installed according to another method, which includes the following steps: first, the new inner gland assembly is positioned around the shaft 4, and the outer gland 3 is pressing the inner gland assembly so that the adjoining portion 31 comes into contact with the adjoining portion 121 on the outer side of the inner gland 12; second, at least one loosen-prevention component 2 is joined on the annular groove 122 of the inner gland 12; third, the outer gland 3 is turned so as to make the slots 32 face the threaded holes of the rotating equipment respectively; fourth, the bolts 321 are used to fix the outer gland 3 on the fixing side of the shaft box of the rotating equipment, and the large threaded fixing elements 116 are passed through the large threaded holes 115, and turned to the fastening position, wherein the large threaded fixing elements 116 are closely in contact with the shaft 4; finally, the small threaded fixing elements 113 and the fixing pieces 114 are removed.

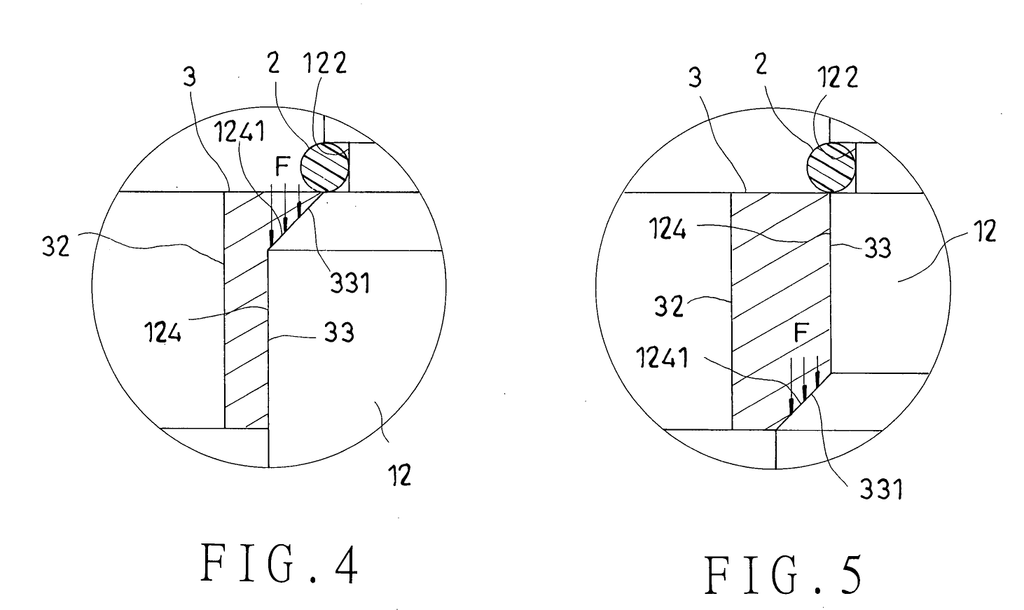

Shown in FIG. 4 is a second preferred embodiment of the present invention: the second embodiment includes an inner gland 12, and an outer gland 3, which are slightly different from the equivalents of the first embodiment: the inner gland 12 has an adjoining portion 124 on an outer side thereof, which includes an upper sloping section 1241, and a lower vertical section; the outer gland 3 has an inner adjoining portion 33, which includes an upper sloping section 331, and a lower vertical section, and which is positioned around the inner gland 12 with the upper sloping sections 1241 and 331 being closely in contact, and the lower vertical sections being closely in contact. Therefore, the inner and the outer glands 12 and 3 will come further closely in contact with each other and subjected to a more uniformly distributed force when they are subjected to high pressure and vibration.

Shown in FIG. 5 is a third preferred embodiment of the present invention: the third embodiment includes an inner gland 12, and an outer gland 3, which are slightly different from the equivalents of the first embodiment: the inner gland 12 has an adjoining portion 124 on an outer side thereof, which includes a lower sloping section 1241; the outer gland 3 has an inner adjoining portion 33, which includes a lower sloping section 331, and which is positioned around the inner gland 12 with the lower sloping sections 1241 and 331 being closely in contact.

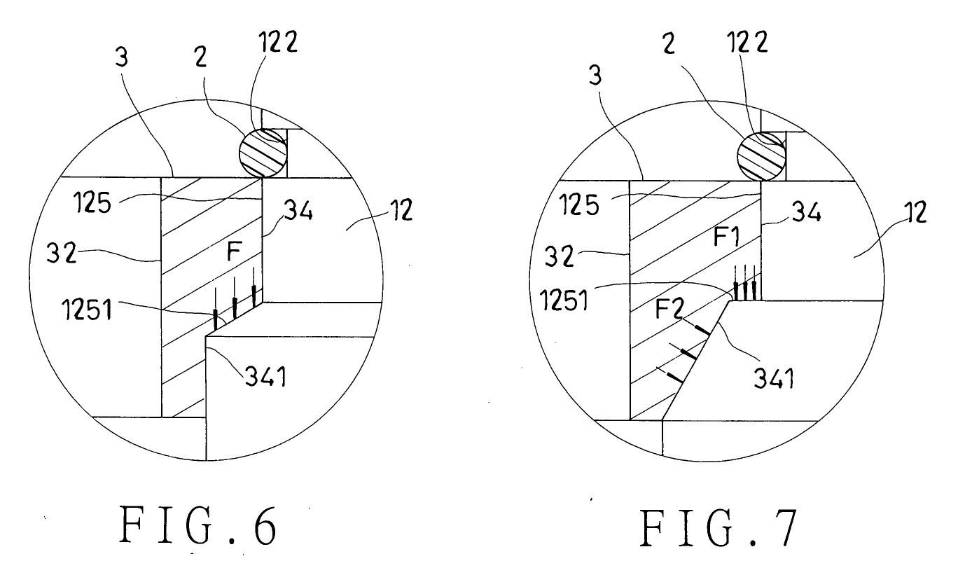

Shown in FIG. 6 is a fourth preferred embodiment of the present invention: the fourth embodiment includes an inner gland 12, and an outer gland 3, which are slightly different from the equivalents of the first embodiment: the inner gland 12 has an adjoining portion 125 on an outer side thereof, which includes a middle bending section 1251 having both a sloping portion and a vertical portion adjoining a lower end of the sloping portion; the outer gland 3 has an inner adjoining portion 34, which includes a middle bending section 341 having a sloping portion, and there is a lower vertical portion adjoining a lower end of the sloping portion of the middle bending section 341.

Shown in FIG. 7 is a fifth preferred embodiment of the present invention: the fifth embodiment includes an inner gland 12, and an outer gland 3, which are slightly different from the equivalents of the first embodiment: the inner gland 12 has an adjoining portion 125 on an outer side thereof, which includes a middle bending section 1251 having both a horizontal portion and a sloping portion under the horizontal portion; the outer gland 3 has an inner adjoining portion 34, which includes a middle bending section 341 having a horizontal portion, and there is a sloping portion under the horizontal portion of the middle bending section 341.

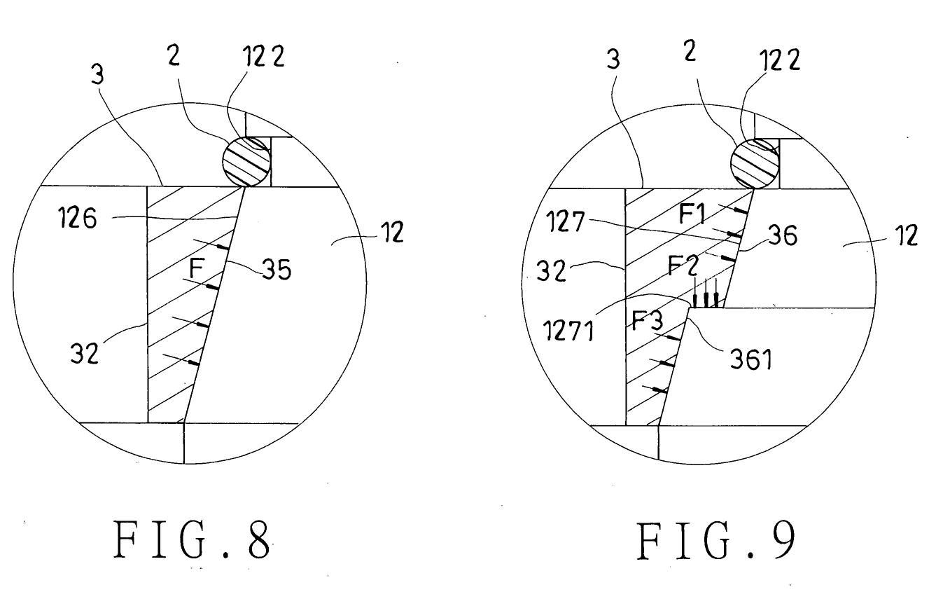

Shown in FIG. 8 is a sixth preferred embodiment of the present invention: the sixth embodiment includes an inner gland 12, and an outer gland 3, which are slightly different from the equivalents of the first embodiment: the inner gland 12 has a sloping adjoining portion 126 on an outer side thereof while the outer gland 3 has a sloping adjoining portion 35 on an inner side thereof.

Shown in FIG. 9 is a seventh preferred embodiment of the present invention: the seventh embodiment includes an inner gland 12, and an outer gland 3, which are slightly different from the equivalents of the first embodiment: the inner gland 12 has an adjoining portion 127 on an outer side thereof, which includes a middle bending section 1271 having both a horizontal portion and a sloping portion under the horizontal portion; the outer gland 3 has an inner adjoining portion 36, which includes a bending section 361 having a horizontal portion; there is a sloping portion under the horizontal portion of the bending section 361 of the outer gland 3.

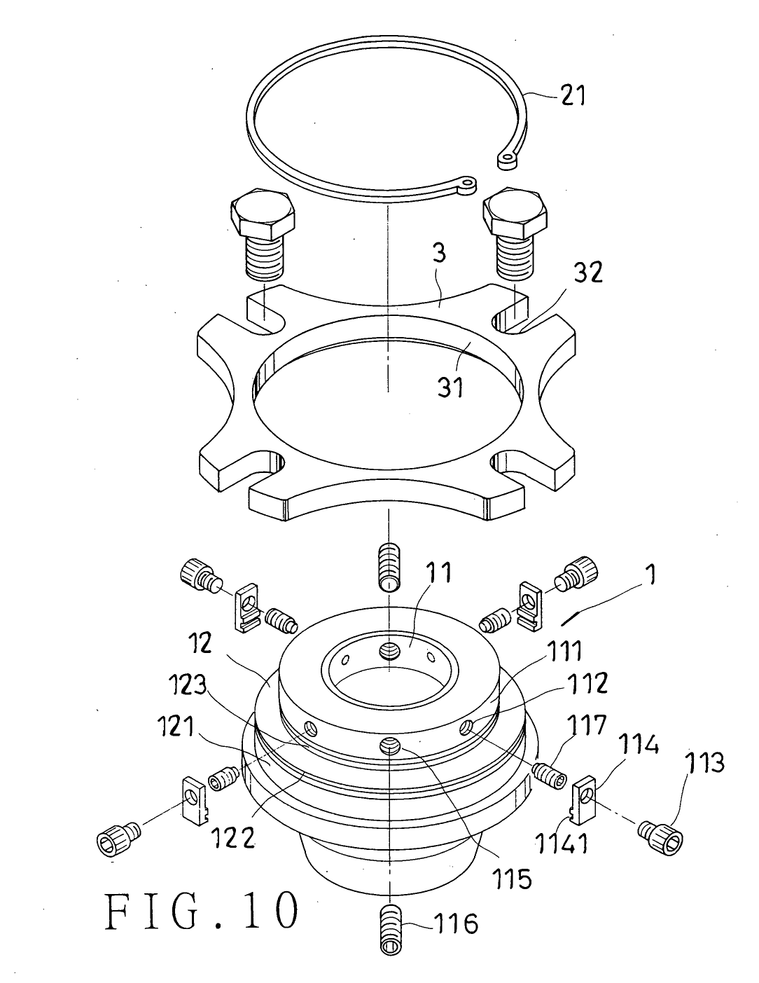

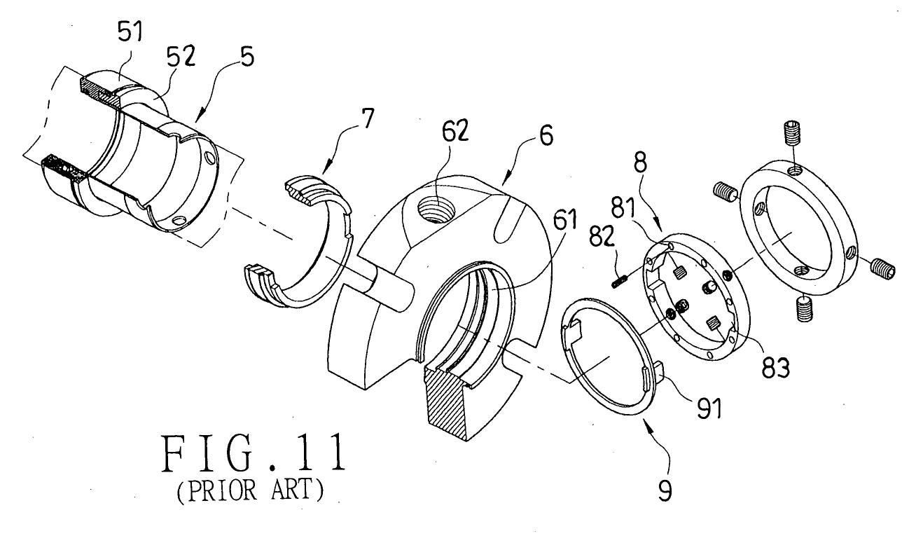

Shown in FIG. 10 is an eighth preferred embodiment of the present invention: the eighth embodiment is basically the same as the first one, yet it has a C-shaped fastening piece 21 to serve as the loosen-prevention component; the C-shaped fastening piece 21 is joined on an annular groove 122 of an inner gland 12 to prevent an outer gland 3 from separating from the inner gland 12. The inner gland assembly 1 includes all basic components of a cartridge seal, being a packaged and sealed type of device. The present invention has the following basic features: first, the outer gland 3 being pressed against and restraining the inner gland assembly 1; second, the sleeve 11 and the inner gland 12 and all other parts of the cartridge seal except for the outer gland 3 being joined together to form a body or packaged and sealed together; third, the outer gland 3 being rotated to a correct position. Nevertheless, the scope of the present invention is to be defined solely by the appended claims.

From the above description, it can be seen that the separable glands for a cartridge seal of the present invention have the following advantages:

1. The inner and the outer glands are made separately; because process fluid will circulate through the inner gland, the material of the inner gland has to be chosen from a group of materials with different anticorrosive capabilities according to the property of the process fluid; because process fluid won't circulate through the outer gland, the outer gland can be made of ordinary materials. Consequently, the material cost of the cartridge seal is relatively low.

2. The outer gland can be easily rotated for its slots to face the threaded holes of the shaft box of the rotating equipment respectively; after the slots face the threaded holes, the workman is allowed to pass the bolts through the slots and into the threaded holes of the shaft box to fix the outer gland. After repair and maintenance, the present invention can be installed without having to move or rotate the shaft. And, the cartridge seal can be easily installed even if the sleeve is tight around the shaft. Furthermore, after installation, the outer gland will restrain the inner gland so that both the inner and the outer glands are steady, and can't become loose even if they are subjected to high pressure.

3. After the bolts are turned to the fastening position to fix the outer gland on the shaft box of the rotating equipment, the adjoining portion of the outer gland will come closely in contact with the adjoining portion of the inner gland, and in turn the inner and the outer glands will be subjected to a uniformly distributed pressure. Consequently, the inner and the outer glands can't deform or loosen even if they are subjected to high pressure or vibration for a long period of time.

4. The loosen-prevention component is positioned on the annular groove of the inner gland. Therefore, the outer gland can't separate from the inner gland, yet it still can be manually rotated to change orientation. In other words, the installation of the present invention will be relatively easy.

5. The inner gland can be replaced with a new one alone while the outer gland can be used forever. And, the outer gland can match up with different models of inner gland assemblies and cartridge seals with different model numbers; in other words, cartridge seals with different diameters and made in accordance with different equipment's standards, e.g. ISO/DIN/ANSI/API, can match up well according to the present invention. Therefore, the present invention is very commercially valuable.

6. The inner gland assembly of the cartridge seal of the present invention includes all basic components of a cartridge seal, being a packaged and sealed type of device. And, a separate outer gland and several fixing bolts are adopted to join the present invention to the rotating equipment while fixing bolts are used to fix the prior art without any separate gland. Therefore, the present invention is relatively easy to install as compared with the prior art.

7. The inner gland assembly is indirectly fastened with the bolts, which provide the force to press the outer gland against the inner gland; the adjoining portion of the inner gland will be always subjected to a uniformly distributed force from the outer gland no matter in what order the bolts are turned to the fastening position. Therefore, it takes less labor and time to install the cartridge seal after the cartridge seal has been separated from the rotating equipment for allowing the cartridge seal to be repaired or maintained. Furthermore, the adjoining portions of the inner and the outer glands of the second to the seventh embodiments have sloping sections; if the inner and the outer glands are subjected to high pressure or constant vibration, they will come even more closely in contact with each other, and in turn the inner gland will be pressed and completely restrained by the outer gland.

What is claimed is:

1. Separable glands for a cartridge seal, comprising
an inner gland assembly; the inner gland assembly including a sleeve, at least one inner gland, and plural cartridge seal components, which are packaged and sealed together; the inner gland having an adjoining portion on an outer side thereof; and an outer gland positioned around the inner gland; the outer gland having an adjoining portion on an inner side thereof; the outer gland restraining the inner gland with the adjoining portion thereof being in contact with the adjoining portion of the inner gland; the inner gland having at least one loosen-prevention component joined thereon; the outer gland being restrained by the loosen-prevention components in such a manner as to be capable of being rotated to adjust position.

2. The separable glands for a cartridge seal as claimed in claim 1, wherein the adjoining portions of the inner and the outer glands are step-shaped.

3. The separable glands for a cartridge seal as claimed in claim 1, wherein each of the adjoining portions of the inner and the outer glands includes a sloping section.

4. The separable glands for a cartridge seal as claimed in claim 1, wherein each of the adjoining portions of the inner and the outer glands includes a bending section.

5. The separable glands for a cartridge seal as claimed in claim 1, wherein the inner gland has an annular groove thereon, and the loosen-prevention component is joined on the annular groove.

6. The separable glands for a cartridge seal as claimed in claim 1, wherein the loosen-prevention component is an elastic piece.

7. The separable glands for a cartridge seal as claimed in claim 1, wherein the loosen-prevention component is a fastener.
